(19) United States
(12) Patent Application Publication
(10) Pub. No.: US 2011/0128948 A1
(43) Pub. Date: Jun. 2, 2011

(54) APPARATUS AND METHOD FOR TRANSMITTING AND RECEIVING DATA

(75) Inventors: Beom Jin Jeon, Seoul (KR); Joong Heon Kim, Seoul (KR)

(73) Assignee: LG ELECTRONICS INC., Seoul (KR)

(21) Appl. No.: 12/997,377

(22) PCT Filed: Jun. 11, 2009
(86) PCT No.: PCT/KR09/03146

§ 371 Date: Jan. 28, 2011

Related U.S. Application Data
(60) Provisional application No. 61/060,484, filed on Jun. 11, 2008.

(30) Foreign Application Priority Data
Nov. 28, 2008 (KR) 10-2008-0119574

(51) Int. Cl. H04W 84/02

(52) U.S. Cl. 370/338

(57) ABSTRACT

Apparatus and method for random access control in a directional communication system is disclosed. The method includes omni-directionally transmitting start time and duration information associated with data to be transmitted, the duration information indicating a duration of transmission of the data to be transmitted to a target station within a random access period; and directionally transmitting, subsequent to the omni-transmitting, the data to the target station beginning at the start time. Data collision caused by overlapped antenna beams linking remote stations can be prevented and communication can be reliably performed.

### TECHNICAL FIELD

The present invention relates to an apparatus and a method for transmitting and receiving data. Although the present invention is suitable for a wide variety of applications, it is particularly suitable for preventing data collisions that may occur in systems utilizing directional beams in the millimeter wavelength band. Overlapping of directional antenna beams carrying data in the millimeter wavelength band may result in errors if data transmission is implemented on a random access based medium access control (MAC) function. Overlapping directional antenna beams may prevent typical carrier sensing circuits from accurately detecting neighboring, potentially interfering carrier signals.

### BACKGROUND ART

The radio frequency band occupying the frequency spectrum between 30 GHz and 300 GHz is referred to as the millimeter wave (mmWave) band. Signals in the mmWave band have a wavelength ranging from about ten millimeters to about one millimeter. The mmWave band is typically used for high data rate transmissions. Data rates on the order of several gigabits per second (Gbps) are possible. In general, the mmWave band is an unlicensed band. It has seen limited use, for example, in communication services, radio astronomy, and vehicle collision prevention.

Carrier frequency and channel bandwidth are among many parameters specified in telecommunications standards. The IEEE 802.11b and IEEE 802.11g standards specify a carrier frequency of 2.4 GHz with a channel bandwidth of about 20 MHz. The IEEE 802.11a and IEEE 802.11n standards specify a carrier frequency of 5 GHz with a channel bandwidth of about 20 MHz. In contrast, a mmWave telecommunication standard calls for a carrier frequency of 60 GHz and a channel bandwidth of 0.5-2.5 GHz. Therefore, mmWave communication calls for both carrier frequency and channel bandwidths that are considerably greater than those of the conventional IEEE 802.11 series standard.

Several advantages are realized by use of a mmWave standard. A radio signal at mmWave is able to provide a considerably high data rate, which is on the order of several gigabits per second (Gbps). Additionally, because the physical wavelength of a mmWave signal is small, communication circuits using mmWave frequencies can be implemented on a single chip, with an area of only 1.5 mm² or less, including an antenna. In addition to data rate and physical size advantages, inter-station interference between stations operating at the 60 GHz carrier frequency of the mmWave standard is reduced in comparison to inter-station interference between stations operating at the 2.4 or 5 GHz carrier frequencies of IEEE 802.11b and IEEE 802.11g standards, respectively. This reduction is realized in part due to a unique phenomenon of higher attenuation of a mmWave signals in air, in comparison to the attenuation of longer wavelength signals at the frequencies used by the IEEE 802.11b and IEEE 802.11g standards.

On the other hand, when comparing a receiver/transmitter pair using a 60 GHz mmWave carrier to a receiver/transmitter pair using a 2.4 or 5 GHz carrier of IEEE 802.11b or IEEE 802.11g, for equal transmitter power, transmitter antenna gain, and distance between stations, the phenomenon of high attenuation of a mmWave signal in air results in lower signal power received at the mmWave receiver antenna than at the IEEE 802.11b or IEEE 802.11g receiver antennas. Thus, if comparing receiver/transmitter station pairs operating under the mmWave and IEEE 802.11 standards, for equal transmitter power, transmitter antenna gain, and receiver sensitivity, the phenomenon of high attenuation of mmWave signals results in decreased distances between mmWave stations if equal carrier power is to be received at all receiver station antennas. Therefore, for a given transmitter power and station separation, one cannot transmit a mmWave signal omni-directionally, while still maintaining signal power at a distant receiver with a signal sufficient for reception and decoding. In order to solve this problem, a mmWave device can transmit a directional beam, instead of an omni-directional beam.

The characteristics of mmWave signals, such as high attenuation in air and small wavelength, make them advantageously useful for line-of-sight communications. If transmission loss is considerable, and transmission power is limited, obtaining communications between two mmWave stations separated by a given distance may be achieved by use of a beam-steerable high-gain antenna array. Thus, a mmWave system can address the problem of high attenuation in air by using an array antenna having a high gain. For this, a method of forming and maintaining a mmWave beam link is required. Receiver/transmitter pairs can make advantageous use of beam steering to implement line-of-sight communications under the mmWave standard.

In a related art application, pluralities of beam links are established for directional line-of-sight communication between a plurality of stations. In such a configuration, beam links may overlap with each other. If MAC is operated for mutual data transmission based on random access, it is possible that a carrier of a potentially interfering station would not be sensed by a station presently transmitting, or about to transmit, due to the directionality of transmitting signals from the potentially interfering station. In this situation, it is possible for a data collision to take place even though conventional MAC was implemented.

If carrier sensing does detect the presence of an interfering signal, a method known as ‘backoff’ may reduce or eliminate collisions. The method of ‘backoff’ involves detecting the presence of a neighboring carrier and then waiting for a random or predetermined amount of time before attempting to transmit data. This method is inefficient. It disrupts the timely flow of data because backoff situations routinely occur and upon each occurrence, the transmission of data is delayed, by a random or predetermined amount of time.

FIG. 1 illustrates an example of a case where directional antenna beams linking pairs of receiving/transmitting stations overlap with each other. In the example of FIG. 1, stations have the characteristic of directional communication. In FIG. 1, the directionality of the beams linking a pair of stations is illustrated as an oval surrounding the pair of stations.

Referring to FIG. 1, four stations A, B, C and D form two receiver/transmitter pairs. At any time, according to the standard used, either station in a pair of stations may transmit or receive data. In the illustration of FIG. 1, respective stations of a pair are assumed to have established beam links. Assume a case that station C is located within the directional beams forming the links between stations A and B. Assume that data transmission to station C from the station D is first performed.

While the transmission to station C from the station D is ongoing, if a data transmission to station A from station B takes place, station C will experience interference to the signal it is receiving from station D. The interference is attributed to the following cause. Namely, as directionality exists in the data transmission to station C from station D, station B is unable to detect the data transmission to station C from station D if conventional carrier sensing is used. In particular, because station B is not able to sense the carrier of station D, each station is unable to detect when a data transmission in the overlapped link takes place. Hence, data transmissions are performed at the same time and data collisions occur.

### DISCLOSURE OF INVENTION

### Technical Problem

Overlapping of directional antenna beams carrying data in the millimeter wavelength band may result in errors if data transmission is implemented on a random access based medium access control (MAC) function. Overlapping directional antenna beams may prevent typical carrier sensing circuits from accurately detecting neighboring, potentially interfering carrier signals.

### Technical Solution

The present invention is directed to an apparatus and method for transmitting and receiving data that substantially obviates one or more of the problems due to limitations and disadvantages of the related art.

A feature of the present invention is to provide an apparatus and method for random access, which eliminates or substantially reduces inter-station interference during the transfer of random access data in the presence of overlapped directional antenna beams, with particular application to directional antenna beams and data transmission/reception under the mmWave standard.

Additional features and advantages of the invention will be set forth in the description which follows, and in part will be apparent from the description, or may be learned by practice of the invention. The features and other advantages of the invention will be realized and attained by the structure particularly pointed out in the written description and claims thereof as well as the appended drawings.

To achieve these and other advantages and in accordance with the purpose of the present invention, as embodied and broadly described, a method for transmitting data from a station includes: first, transmitting duration information via an omni-directional transmission, the duration information identifying a start time, or a channel time, and a duration for the transmission of data to a target station within a random access period; and second, transmitting data to the target station beginning at the start time for the identified duration by a directional transmission.

In one embodiment a method for transmitting data from a station in a plurality of stations includes receiving a start time and duration information defining a period of time within a random access period that will be occupied by a transmission of a signal from another station in the plurality of stations and then, either pausing or not starting a transmission of data during the period of time subsequent to receiving the start time and duration information, and either resuming or starting, respectively, the transmission of data within the random access period, subsequent to expiration of the period of time.

In another embodiment of the invention, an apparatus for transmitting data includes a communication module configured to receive data from an external station, and configured to transmit data to the external station. The apparatus also includes a controller configured to control the communication module to transmit data comprising a start time and duration information by an omni-directional transmission, the duration information indicating a duration of transmission of the data to a target station within a random access period, and to transmit data, subsequent to the omni-directional transmission, to the target station beginning at the start time.

In still another embodiment of the invention, an apparatus for transmitting data includes a communication module configured to receive data from a plurality of station, and configured to transmit data to at least one of the plurality of stations. The apparatus further includes a controller configured to receive the data from the plurality of stations and determine a start time and duration information defining a period of time within a random access period that will be occupied by a transmission of a signal from one of the plurality of stations, and either pause or not start a transmission of data during the period of time subsequent to making the determination, and then either resume or start, respectively, the transmission of data within the random access period, subsequent to expiration of the period of time.

It is to be understood that both the foregoing general description and the following detailed description are exemplary and explanatory and are intended to provide further explanation of the invention as claimed.

### Advantageous Effects

Accordingly, the present invention provides the following effects or advantages.

First, a collision problem, which may be caused by a random access in case of overlapped directional antenna beam linking two stations, can be solved.

Secondly, communications can be reliably performed.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an example of a case where directional antenna beams linking pairs of receiving/transmitting stations overlap with each other;

FIG. 2 illustrates a configuration of a beacon interval according to one exemplary embodiment of the present invention;

FIG. 3 illustrates a random access process according to one exemplary embodiment of the present invention;

FIG. 4 is a flowchart of a random access method according to one exemplary embodiment of the present invention;

FIG. 5 illustrates the potential for data collision when a station, awaking from a sleep mode and not having received or decoded a pseudo-carrier signal, attempts a random access; and

FIG. 6 is a block diagram of a station according to one exemplary embodiment of the present invention.

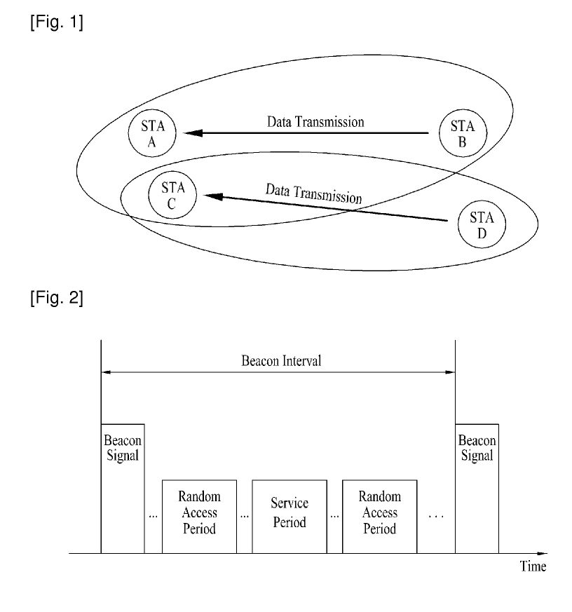

### BEST MODE FOR CARRYING OUT THE INVENTION

To achieve these and other advantages and in accordance with the purpose of the present invention, as embodied and broadly described, a method for transmitting data from a first station includes: omni-directionally transmitting start time and duration information associated with the data, the duration information indicating a duration of transmission of the data to a target station within a random access period; and directionally transmitting, subsequent to the omni-directional transmitting, the data to the target station beginning at the start time.

In one embodiment a method for transmitting data from a station in a plurality of stations includes: receiving a start time and duration information defining a period of time within a random access period that will be occupied by a transmission of a signal from another station in the plurality of stations; either pausing or not starting a transmission of data during the period of time subsequent to receiving the start time and duration information; and either resuming or starting, respectively, the transmission of data within the random access period, subsequent to expiration of the period of time.

In another embodiment of the invention, an apparatus for transmitting data includes a communication module configured to receive data from an external station, and configured to transmit data to the external station. The apparatus also includes a controller configured to control the communication module to transmit data comprising a start time and duration information by an omni-directional transmission, the duration information indicating a duration of transmission of the data to a target station within a random access period, and transmit data, subsequent to the omni-directional transmission, to the target station beginning at the start time.

In still another embodiment of the invention, an apparatus for transmitting data includes a communication module configured to receive data from a plurality of station, and configured to transmit data to at least one of the plurality of stations. The apparatus also includes a controller configured to receive the data from the plurality of stations and determine a start time and duration information defining a period of time within a random access period that will be occupied by a transmission of a signal from one of the plurality of stations, either pause or not start a transmission of data during the period of time subsequent to making the determination, and either resume or start, respectively, the transmission of data within the random access period, subsequent to expiration of the period of time.

### Mode for the Invention

Reference will now be made in detail to the preferred embodiments of the present invention, examples of which are illustrated in the accompanying drawings.

The following exemplary embodiments of the present invention can be modified into various forms and the scope of the present invention including the appended claims and their equivalents is not limited to the following exemplary embodiments.

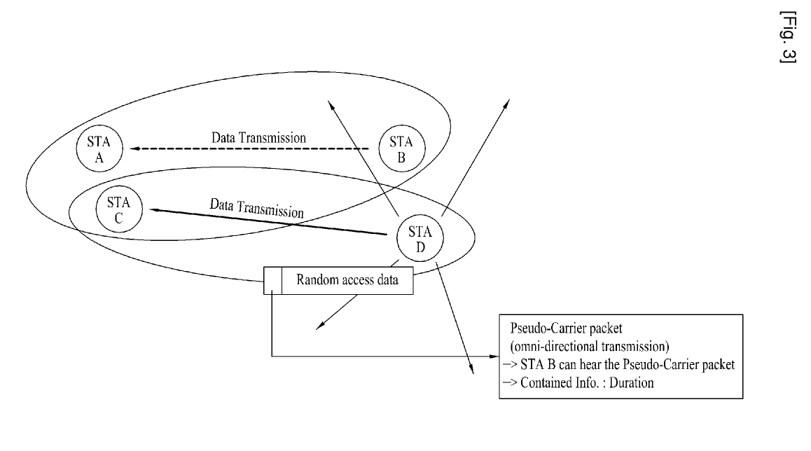

FIG. 2 illustrates a configuration of a beacon interval according to one exemplary embodiment of the present invention. Referring to FIG. 2, a beacon interval of the present invention defines a period between transmissions of beacon signals. A beacon duration, a service period, and a random access period may be included within the time occupied by a beacon interval. The beacon duration defines a given amount of time for transmission of a beacon signal during a beacon interval. The service period may be used to specify a time, or channel time, allocated by a coordinator for data communication by a specific station. The random access period is a time, or channel time, during which a plurality of stations may randomly perform data communications.

According to one embodiment of the present invention, a data packet called a pseudo-carrier packet may be defined. A pseudo-carrier packet is intended to result in an outcome similar to the outcome achieved in a system of stations using carrier sensing and omni-directional transmission. The pseudo-carrier packet is useful when carrier sensing is impossible (or at least may not provide the desired outcome) due to the use of directional transmission.

In particular, by transmitting a pseudo-carrier data packet omni-directionally from a given station prior to transmitting data or a control message, peripheral stations are alerted to the fact that data transmission from the given station is about to begin.

If all data from all stations is transmitted omni-directionally, efficiency is lost because the data bit rate for an omni-directionally transmitted signal must be less than the data bit rate of a directionally transmitted signal for comparable signal decoding. Therefore, a method, used by a station in a plurality of stations, of securing a channel by specifying a time, or a channel time, and a duration of time within which to transfer data may be used. On the other hand, if a given station previously reserved time, or channel time, for transferring data, a pseudo-carrier signal is not necessary. As mentioned in the foregoing description, the reservation of a time, or channel time, for transmission of data from a given station may occur during a service period.

There may occur a situation in which the amount of time needed to transmit data to a target station exceeds the amount of time allotted for such transmission. In such a situation, a station may pause its transmission of data at the expiration of the allotted time for transmission and resume data transmission at a later time.

The pseudo-carrier data packet may include duration information concerning a message or data that will be transmitted subsequent to the transmission of the pseudo-carrier data-packet. A peripheral station emerging from a sleep mode may be configured to perform data transmission after a beginning of a beacon interval beginning after the station emerges from the sleep mode.

FIG. 3 illustrates a random access process according to one exemplary embodiment of the present invention. Referring to FIG. 3, station D first transmits a pseudo-carrier packet omni-directionally, instead of transmitting data or a control message immediately. The pseudo-carrier packet may include information detailing the duration of the data or message that will be transmitted from station D.

Because the pseudo-carrier packet is transmitted omni-directionally, station B receives the pseudo-carrier packet. Had the pseudo-carrier packet been transmitted directionally from station D to station C, station B would not have received the packet due to the directionality of transmitted signal. Upon receipt and decoding of the omni-directionally transmitted pseudo-carrier packet, station B delays any pending transmissions at least until the duration of transmission specified in the pseudo-carrier signal received from station D expires. Therefore, the pseudo-carrier packet results in the same effect that would have occurred using conventional carrier sensing. Namely, even if data was to be transmitted from the station B to station A, station B stands by until at least a point in time subsequent to completion of the data transmission from station D to station C.

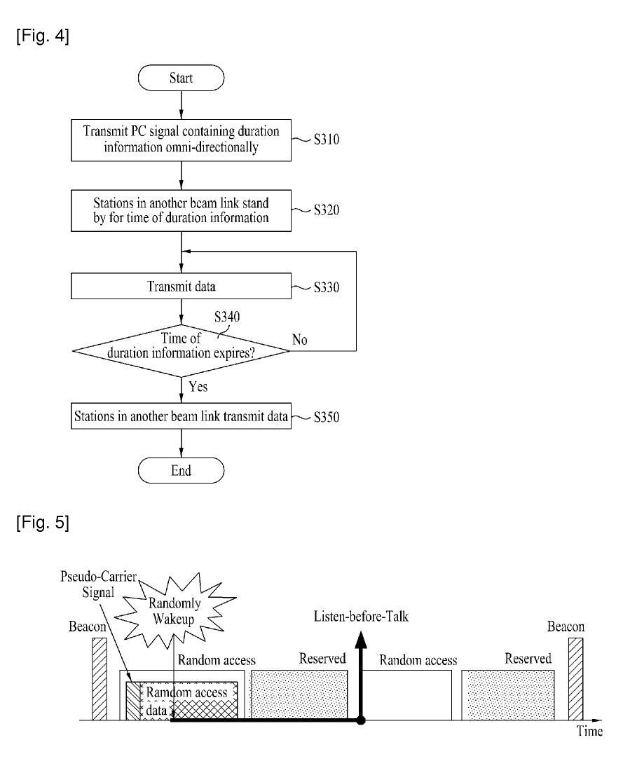

FIG. 4 is a flowchart of a random access method according to one exemplary embodiment of the present invention. Referring to FIG. 4, a first station in a plurality of stations, attempting to transmit random access data, omni-directionally transmits a pseudo-carrier signal containing at least one pseudo-carrier data packet including transmission start time, or channel time, and duration information for the desired transmission [S310].

Other stations, in the vicinity of the omni-directionally transmitted pseudo-carrier signal from the first station, may receive the pseudo-carrier signal. In response, each of the other stations executes code to maintain a standby state, i.e., they do not transmit data, beginning at the time, or channel time, identified for the beginning of the transmission and for the duration of the transmission, as specified by the data in the pseudo-carrier packet.

Consequently, the first station transmits the random access data to a corresponding second station, for reception by the second station. The transmission may begin consecutive to the transmission of the pseudo-carrier signal, or at a channel timing point defined by the data in the pseudo carrier signal [S330]. The first station preferably transmits the random access data to the second station using a directional antenna beam.

Either before or upon expiration of the length of time reserved for the transmission, the first station completes its transmission of the random access data. Upon expiration of the time reserved by the first station for the transmission of data [S340], the remainder of the plurality of stations resume their data transmissions [S350]. Accordingly, data collisions between stations in the plurality of stations are avoided, despite the use of directional antenna forming links between and among individual ones of the plurality of stations.

FIG. 5 illustrates the potential for data collision when a station, awaking from a sleep mode and not having received or decoded a pseudo-carrier signal, attempts a random access. As will be understood, each station on a wireless network will, from time-to-time, enter a sleep mode. If a station, upon waking up from a sleep mode as shown in FIG. 5, transmits random access data to peripheral stations, a problem may occur. In this circumstance, a station that wakes up at a random time at the conclusion of a sleep mode may not have received and/or decoded a previous pseudo-carrier signal. This may adversely affect data communication that is presently occurring between other stations as explained below. Namely, as the randomly-waking station has not executed code based on information included in the un-received pseudo-carrier signal, it may attempt to perform a data transmission immediately upon waking. Therefore, a data collision may occur.

In this case, because the station that just emerged from its sleep mode does not have a record of the previous communication; it would be advantageous to configure it to refrain from transmission until after the start of a new beacon interval.

Alternatively, the following advantageous method is also available. First, after a station has woken up from a sleep mode, it may not be allowed to perform a random access data transmission after completion of the wake-up operation. In particular, after a wireless station has woken up, it may be allowed to start a communication in a next random access period by ‘listen-before-talk’.

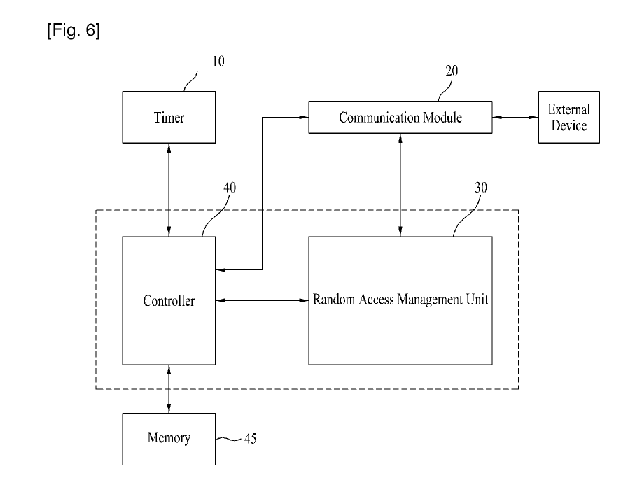

FIG. 6 is a block diagram of a station according to one exemplary embodiment of the present invention. Referring to FIG. 6, a station according to one embodiment of the present invention includes a timer 10, a communication module 20, a random access management unit 30, and a controller 40.

The timer 10 plays a role in indicating a start and end of a beacon interval indicating an interval between a transmission of a beacon signal and a transmission of a next beacon signal or an interval between a beacon period and a next beacon period. The timer 10 is able to provide time information within the beacon interval. For instance, the timer 10 is able to indicate start and end points of a beacon period for transmitting a beacon signal within the beacon interval, start and end points of a random accessible period for random accessibility of a plurality of stations within the beacon interval, and start and end points of a service period allocated by a coordinator to a data communication of a specific station.

The communication module 20 plays a role in transmitting data or a signal to another station or the coordinator. In addition, the communication module 20 plays a role in receiving data or a signal transmitted by another station or the coordinator.

The random access management unit 30 may generate a pseudo-carrier packet in support of the method of performing random access data communication as described herein. The random access management unit 30 is able to generate both a time or a channel time as well as duration information of the random access data to be transmitted by its station.

The controller 40 controls the random access management unit 30 in support of the generation of the pseudo-carrier packet, and also controls the communication module in support of transmitting or receiving pseudo-carrier signals and all data transmitted from the station to one or more other stations, or received by the station from one or more other stations.

The controller 40, either alone or in coordination with the communication module 20, may coordinate transmission and reception of signals from either an omni-directional antenna or a directional antenna (not shown).

A memory 45 may be functionally coupled to at least the controller 40. The memory 45 may store instructions that may be executed by the controller 40 to perform the steps of the method described herein.

If the controller 40 of a first station receives a pseudo-carrier packet including start time or channel time and duration data from a second station, via the communication module 20 of the first station, the first station is able to control its data exchange (transmission/reception) with third and subsequent stations (collectively ‘other stations’) by stopping or rescheduling data transmission with those other stations beginning at the time or channel time and lasting for the duration specified in the pseudo-carrier packet.

The controller 40 is also able to control data to be exchanged (transmitted/received) with a specific station for the channel time allocated by a coordinator (not shown) according to data transmitted within the service period.

In this disclosure of the present invention, roles of the controller 40 and the random access management unit 30 are separately described. It is understood that the controller 40 can perform the functions of both it and the random access management unit 30.

### INDUSTRIAL APPLICABILITY

Accordingly, the present invention relates to a random access method, by which a collision problem possibly caused by a random access in case of overlapped directional antenna beams linking pairs of stations can be solved and by which communication between those stations can be reliably performed. The present invention is applicable to wireless transceivers in a directionally-based wireless communication system network utilizing a mmWave standard.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A method for transmitting data from a first station, the method comprising:
omni-directionally transmitting start time and duration information associated with the data, the duration information indicating a duration of transmission of the data to a target station within a random access period; and
directionally transmitting, subsequent to the omni-directional transmitting, the data to the target station beginning at the start time.

2. The method of claim 1, wherein the duration defines a length of channel time during which the target station and all stations other than the first station should not transmit.

3. The method of claim 1, further comprising:
pausing the transmission of data from the first station to the target station within the random access period when the duration expires.

4. The method of claim 1, further comprising:
transmitting data to the target station beginning at an allocated channel time, if the allocated channel time is provided within a service period by a coordinator.

5. The method of claim 1, wherein the duration information is transmitted within the random access period.

6. A method for transmitting data from a station in a plurality of stations, the method comprising:
receiving a start time and duration information defining a period of time within a random access period that will be occupied by a transmission of a signal from another station in the plurality of stations;
either pausing or not starting a transmission of data during the period of time subsequent to receiving the start time and duration information; and
either resuming or starting, respectively, the transmission of data within the random access period, subsequent to expiration of the period of time.

7. The method of claim 6, wherein the duration information is received within the random access period.

8. An apparatus for transmitting data, the apparatus comprising:
a communication module configured to receive data from an external station, and configured to transmit data to the external station; and
a controller configured to control the communication module to:
transmit data comprising a start time and duration information by an omni-directional transmission, the duration information indicating a duration of
transmission of the data to a target station within a random access period; and
transmit data, subsequent to the omni-directional transmission, to the target station beginning at the start time.

9. The apparatus of claim 8, wherein the duration defines a length of channel time during which interference will not occur.

10. The apparatus of claim 8, wherein the controller is further configured to pause the transmission of data from the apparatus to the target station within the random access period when the duration expires.

11. The apparatus of claim 8, wherein the controller is further configured to control the communication module to transmit data to the target station beginning at an allocated channel time, if the allocated channel time is provided within a service period by a coordinator.

12. The apparatus of claim 8, wherein the duration information is transmitted within the random accessible period.

13. An apparatus for transmitting data, the apparatus comprising:
a communication module configured to receive data from a plurality of station, and configured to transmit data to at least one of the plurality of stations; and
a controller configured to:
receive the data from the plurality of stations and determine a start time and duration information defining a period of time within a random access period that will be occupied by a transmission of a signal from one of the plurality of stations;
either pause or not start a transmission of data during the period of time subsequent to making the determination; and
either resume or start, respectively, the transmission of data within the random access period, subsequent to expiration of the period of time.

14. The apparatus of claim 13, wherein the duration information is received within the random access period.
